(19) United States
(12) Patent Application Publication
(10) Pub. No.: US 2026/0074610 A1
(43) Pub. Date: Mar. 12, 2026

(54) MULTI-PHASE VOLTAGE CONVERSION DEVICE

(71) Applicant: Montage Technology (Kunshan) Co., Ltd., Suzhou (CN)

(72) Inventors: Zongjie Hu, Shanghai (CN); Xuexin Ding, Shanghai (CN)

(73) Assignee: Montage Technology (Kunshan) Co., Ltd., Suzhou (CN)

(21) Appl. No.: 19/312,248

(22) Filed: Aug. 27, 2025

(30) Foreign Application Priority Data
Sep. 6, 2024 (CN) 202411247624.3

(51) Int. Cl. H02M 1/32; H02M 1/00; H02M 1/44; H02M 3/157

(52) U.S. Cl. CPC H02M 1/32; H02M 1/0009; H02M 1/44; H02M 3/157

(57) ABSTRACT

Disclosed is a multi-phase voltage conversion device, including multiple voltage converters, multiple current sensors and multiple current sensing signal generators. The multiple voltage converters are connected in parallel, and respectively generate an output voltage according to multiple control signals. The multiple current sensors correspond to the multiple voltage converters one by one. Each current sensor is coupled to two ends of the switching switch of the corresponding voltage converter for sensing the sensed current on the switching switch. The multiple current sensing signal generators correspond to the multiple current sensors one by one, each current sensing signal generator is coupled to the corresponding current sensor, generates mirror current by mirroring the sensed current, and generates current sensing signal according to the mirror current and the output voltage. The multi-phase voltage conversion device determines whether to activate the overcurrent protection mechanism according to the current sensing signal.

### CROSS-REFERENCE TO RELATED APPLICATION

This application claims the priority benefit of China application serial no. 202411247624.3, filed on Sep. 6, 2024. The entirety of the above-mentioned patent application is hereby incorporated by reference herein and made a part of this specification.

### BACKGROUND

### Field of the Disclosure

The present disclosure relates to a multi-phase voltage conversion device, particularly to a multi-phase voltage conversion device for reducing the probability of false triggering an overcurrent protection (OCP) mechanism.

### Description of Related Art

In a multi-phase voltage conversion device, due to multiple voltage converters sharing the same reference ground voltage, mutual interference occur when these voltage converters respectively execute voltage switching operations. To ensure the safety of operation of the multi-phase voltage conversion device, it is necessary to provide an overcurrent protection mechanism therein. The multi-phase voltage conversion device determines whether to activate the overcurrent protection mechanism by detecting whether the current at the switching ends of each voltage converter exceeds a threshold. However, in the existing technology, when detecting the current at the switching ends of each voltage converter, surge currents might occur at these ends due to interference generated by the switching operations of various voltage converters. The occurrence of surge currents might cause the multi-phase voltage conversion device to erroneously determine that an overcurrent phenomenon has occurred, which incorrectly activates the overcurrent protection mechanism and renders the multi-phase voltage conversion device inoperative.

### SUMMARY OF THE DISCLOSURE

The present disclosure provides a multi-phase voltage conversion device for improving the accuracy of overcurrent detection operation, thus avoiding the interference generated by the switching operations of multiple voltage converters that might erroneously start the overcurrent protection mechanism.

According to an embodiment of the present disclosure, a multi-phase voltage conversion device includes multiple voltage converters, multiple current sensors, and multiple current sensing signal generators. The multiple voltage converters are connected in parallel, and respectively generate an output voltage according to multiple control signals. The multiple current sensors correspond to the multiple voltage converters one by one, and each current sensor is coupled to two ends of a switching switch of the corresponding voltage converter for sensing a sensed current on the switching switch. The multiple current sensing signal generators correspond to the multiple current sensors one by one, and each current sensing signal generator is coupled to the corresponding current sensor, generates a mirror current by mirroring the sensed current, and generates a current sensing signal according to the mirror current and the output voltage. The multi-phase voltage conversion device determines whether to activate an overcurrent protection mechanism according to the current sensing signal.

### BRIEF DESCRIPTION OF THE DRAWINGS

FIG. 1 shows a schematic view of a multi-phase voltage conversion device according to an embodiment of the present disclosure.

FIG. 2A shows a schematic view of a multi-phase voltage conversion device according to another embodiment of the present disclosure.

FIG. 2B shows a signal generating circuit for determining a first time interval and a second time interval in the multi-phase voltage conversion device of the embodiment of FIG. 2A.

FIG. 2C shows a timing diagram of the multi-phase voltage conversion device of the embodiment of FIG. 2A.

FIG. 3 shows a schematic view of a multi-phase voltage conversion device according to another embodiment of the present disclosure.

FIG. 4A shows a schematic view of an implementation mode of a controller in a multi-phase voltage conversion device according to an embodiment of the present disclosure.

FIG. 4B shows a timing diagram of an anti-transient interference circuit 410 of the embodiment of FIG. 4A of the present disclosure.

### DESCRIPTION OF EMBODIMENTS

The following explains the implementation mode of the present disclosure through specific examples. Those skilled in the art may easily understand other advantages and effects of the present disclosure from the content disclosed in this specification. The present disclosure may also be implemented or applied through other specific implementations, and various details in this specification may also be modified or changed based on different perspectives and applications, without departing from the spirit of the present disclosure. It should be noted that, in non-conflicting situations, the examples below and the features in these examples may be combined with each other.

It should be noted that the illustrations provided in the following embodiments only illustrate the basic concept of the present disclosure in a schematic manner. Therefore, the illustrations only show components related to the present disclosure rather than being drawn according to the actual number, shape, and dimensions of components during implementation. In actual implementation, the type, quantity, and proportion of each component may be changed freely, and the layout pattern of the components may also be more complex.

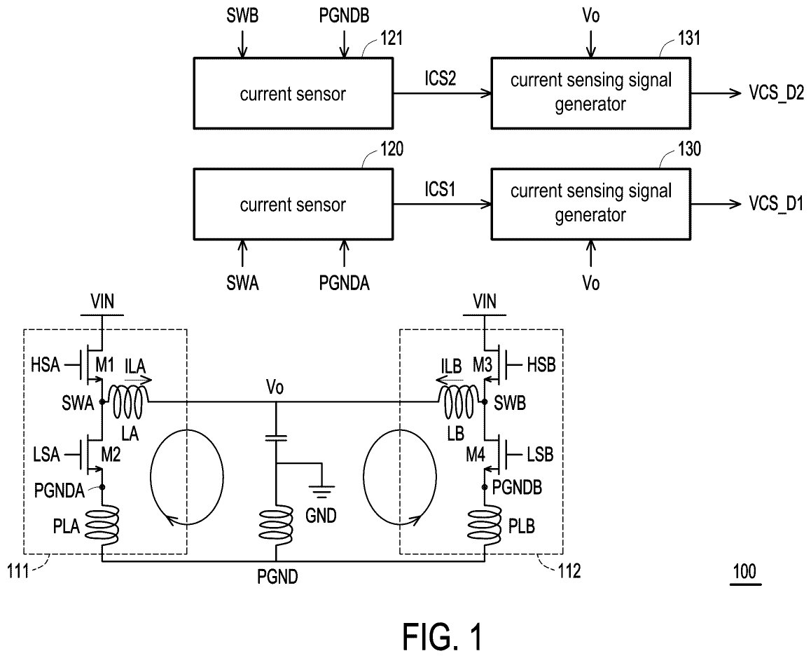

Please refer to FIG. 1, FIG. 1 shows a schematic view of a multi-phase voltage conversion device according to an embodiment of the present disclosure. The multi-phase voltage conversion device 100 includes voltage converters 111 and 112, a current sensor 120 and a current sensing signal generator 130, a current sensor 121 and a current sensing signal generator 131. The voltage converters 111 and 112 are connected in parallel, wherein the voltage converters 111 and 112 both receive an input voltage VIN, and commonly generate an output voltage Vo. The voltage converter 111 includes transistors M1 and M2, an inductor PLA and an inductor LA, wherein the transistors M1 and M2 are coupled in series between the input voltage VIN and a reference ground voltage PGND. The coupling point between the transistors M1 and M2 forms a switch end SWA. One end of the inductor LA is coupled to the switch end SWA, and the other end of the inductor LA generates the output voltage Vo. The voltage converter 112 includes transistors M3 and M4, an inductor PLB and an inductor LB, wherein the transistors M3 and M4 are coupled in series between the input voltage VIN and the reference ground voltage PGND. The coupling point between the transistors M3 and M4 forms a switch end SWB. One end of the inductor LB is coupled to the switch end SWB, and the other end of the inductor LB is coupled to the inductor LA, and together with the inductor LA generates the output voltage Vo. The inductor PLA is coupled between the transistor M2 and the reference ground voltage PGND, while the inductor PLB is coupled between the transistor M4 and the reference ground voltage PGND. The coupling point between the inductor PLA and the transistor M2 is a coupling point PGNDA, and the coupling point between the inductor PLB and the transistor M4 is a coupling point PGNDB. Currents ILA and ILB flow through inductors LA and LB respectively.

The transistors M1˜M4 are respectively controlled by control signals HSA, LSA, HSB, and LSB, wherein the phases between control signals HSA and LSA are complementary to each other, and the phases between control signals HSB and LSB are complementary to each other. The transistors M1˜M4 are used as switching switches to convert the input voltage VIN to generate output voltage Vo through switching operations.

The current sensor 120 is coupled to the voltage converter 111. Specifically, the current sensor 120 may be coupled between the two ends of the transistor M2, that is, one end of the current sensor 120 is coupled to the switch end SWA, and the other end is coupled to the coupling point PGNDA. The current sensor 120 may sense a current flowing through the transistor M2 via the switch end SWA and coupling point PGNDA and obtain a sensed current ICS1.

The current sensing signal generator 130 is coupled to the current sensor 120. The current sensing signal generator 130 generates a mirror current through the sensed current ICS1 generated by the mirror current sensor 120, and generates a current sensing signal VCS_D1 according to the mirror current and the output voltage Vo, wherein the current sensing signal VCS_D1 is used to reflect the change of the sensed current ICS1.

Specifically, the current sensing signal generator 130 may charge a capacitor according to the mirror current in a first time interval, and generate a discharge current according to the output voltage Vo in a second time interval after the first time interval, and discharge the capacitor according to the generated discharge current to obtain a gradually dropping current sensing signal VCS_D1. Furthermore, the multi-phase voltage conversion device 100 may compare the current sensing signal VCS_D1 with a predetermined reference threshold to determine whether an overcurrent has occurred in the multi-phase voltage conversion device 100. When determining that an overcurrent has occurred, the multi-phase voltage conversion device 100 activates an overcurrent protection mechanism.

It is worth noting that the current sensing signal VCS_D1 obtained by the current sensing signal generator 130 may reflect the change of the sensed current ICS1. Moreover, when the transistors M1˜M4 perform switching operations, the switching operations of the transistors M3 and M4 will not interfere with the current sensing signal VCS_D1, which means that the current sensing signal VCS_D1 will not experience jitter due to interference generated by the switching operations of the transistors M3 and M4 during the voltage conversion operation of the multi-phase voltage conversion device 100. As a result, the multi-phase voltage conversion device 100 may avoid false triggering the overcurrent protection mechanism due to jitter generated by switching operations, ensuring the normal operation of the multi-phase voltage conversion device 100.

The current sensor 121 is coupled to the voltage converter 112. Specifically, the current sensor 121 may be coupled between the two ends of the transistor M4, that is, one end of the current sensor 121 is coupled to the switch end SWB, and the other end is coupled to the coupling point PGNDB. The current sensing signal generator 131 is coupled to the current sensor 121. The current sensing signal generator 131 generates mirror current through the sensed current ICS2 generated by the mirror current sensor 121, and generates the current sensing signal VCS_D2 according to the mirror current and the output voltage Vo. The current sensing signal VCS_D2 is used to reflect the changes of the sensed current ICS2. The current sensor 121 and the current sensing signal generator 131 have similar circuit architectures and similar operation modes to the current sensor 120 and the current sensing signal generator 130, respectively, which will not be described in detail here.

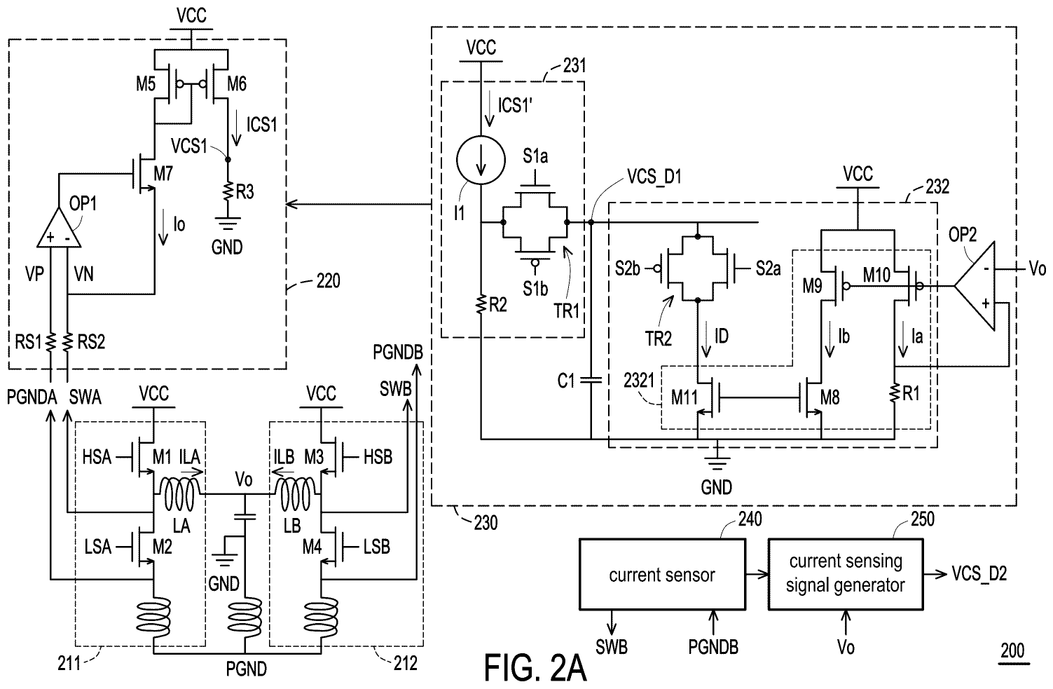

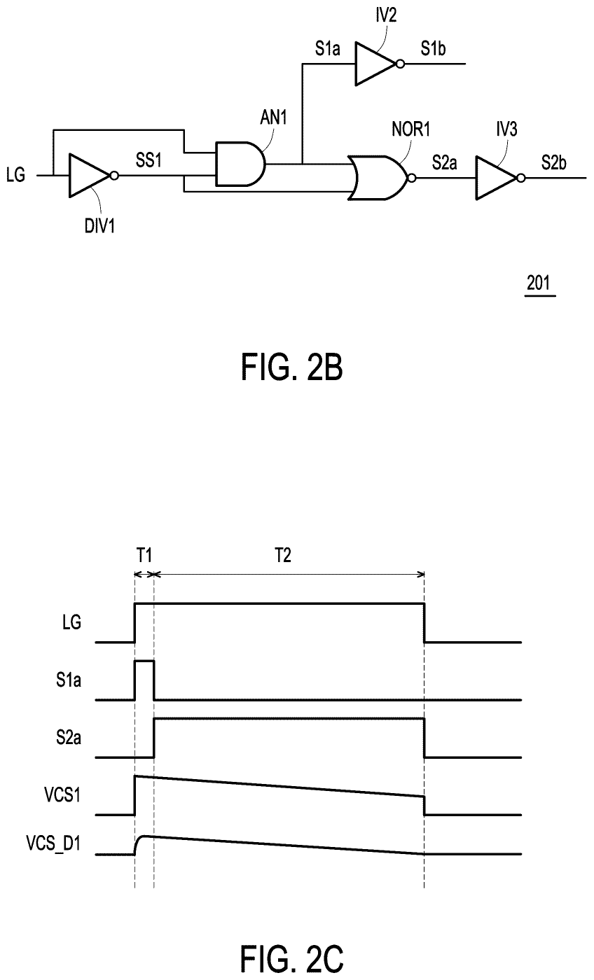

Please refer to FIG. 2A, FIG. 2A shows a schematic view of a multi-phase voltage conversion device according to another embodiment of the present disclosure. The multi-phase voltage conversion device 200 includes voltage converters 211 and 212, a current sensor 220, a current sensing signal generator 230, a current sensor 240, and a current sensing signal generator 250. The voltage converters 211 and 212 are similar to the voltage converters 111 and 112 in FIG. 1, which will not be elaborated here. The current sensor 220 includes transistors M5˜M7, an amplifier OP1, and resistors RS1 and RS2. The positive and negative input ends of the amplifier OP1 are coupled to the coupling point PGNDA and the switch end SWA through resistors RS1 and RS2, respectively. The amplifier OP1 generates a bias based on the difference between a voltage VP at its positive input end and a voltage VN at its negative input end, and provides the bias to the control end of the transistor M7. The transistor M5 and the transistor M6 are coupled to form a current mirror circuit, and are coupled to the power supply voltage VCC. The transistor M7 may serve as a current source here, and generates a current Io according to the bias provided by an amplifier OP1. The current mirror circuit formed by the transistors M5 and M6 then generates a sensed current ICS1 through the mirror current Io.

The transistor M6 is coupled to the resistor R3. The sensed current ICS1 generated by the transistor M6 flows through the resistor R3, and generates a sensed voltage VCS1 corresponding to the sensed current ICS1 at the coupling point between the resistor R3 and the transistor M6.

The current sensing signal generator 230 includes a capacitor C1, a charging circuit 231, and a discharging circuit 232. The first end of the capacitor C1 may be coupled to the charging circuit 231 and the discharging circuit 232. The second end of the capacitor C1 may be coupled to a ground reference voltage GND. The charging circuit 231 includes a current source I1, a resistor R2, and a switch TR1. The current source I1 provides a mirror current ICS1′ through the sensed current ICS1 generated by the mirror current sensor 220. The current value of the sensed current ICS1 and the current value of the mirror current ICS1′ may have a proportional relationship. The sensed current ICS1 may be greater than, equal to, or less than the mirror current ICS1′. The current source I1 is connected in series with the resistor R2, and the mirror current ICS1′ provided by the current source I1 flows through the resistor R2.

The switch TR1 is coupled between the coupling point of the current source I1 and the resistor R2 and the first end of the capacitor C1. In this embodiment, the switch TR1 may be a transmission gate, and is turned on in the first time interval according to signals S1a and S1b, where signals S1a and S1b have opposite phases. When the switch TR1 is turned on, the capacitor C1 may be charged according to the voltage at the coupling point between the current source I1 and the resistor R2.

The discharging circuit 232 includes a switch TR2 and a current mirror 2321. The switch TR2 is coupled between the first end of the capacitor C1 and the current mirror 2321. In this embodiment, the switch TR2 is also a transmission gate, and is controlled by the signals S2a and S2b, where signals S2a and S2b have opposite phases. The switch TR2 is turned on in a second time interval after the first time interval, and when the switch TR2 is turned on, the switch TR1 is turned off. During the first time interval when the switch TR1 is turned on, the switch TR2 is turned off.

The current mirror 2321 includes transistors M8˜M11. The current mirror 2321 is coupled to the power supply voltage VCC. The control ends of the transistors M9 and M10 receive the voltage provided by the amplifier OP2 to generate currents Ib and Ia respectively. The current Ia flows through the resistor R1 to generate feedback voltage at the positive input end of the amplifier OP2. The current Ib flows through the transistor M8, causing a discharge current ID to be generated at the coupling point between the transistor M11 and the switch TR2. When the switch TR2 is turned on, the capacitor C1 may be discharged according to the discharge current ID.

By charging the capacitor C1 through the charging circuit 231 in the first time interval, and discharging the capacitor C1 through the discharging circuit 232 in the second time interval, a current sensing signal VCS_D1 may be correspondingly generated on the first end of the capacitor C1 to reflect the current flowing through the transistor M2.

On the other hand, the negative input end of the amplifier OP2 may receive the output voltage Vo from the multi-phase voltage conversion device 200. The amplifier OP2 may adjust the bias provided to the control ends of the transistors M9 and M10 according to the changes in the output voltage Vo.

It is worth mentioning that, in this embodiment, the current sensor 240 and the current sensing signal generator 250 may be disposed between the switch end SWB of the transistor M4 and the coupling point PGNDB. The current sensing signal generator 250 may correspondingly generate a current sensing signal VCS_D2 for reflecting the current through the transistor M4. The current sensor 240 and the current sensing signal generator 250 have circuit architectures and operation modes similar to those of the aforementioned current sensor 220 and the current sensing signal generator 230, respectively, which will not be elaborated further here.

Please refer to FIG. 2B, FIG. 2B shows a signal generating circuit for determining the first time interval and the second time interval in the multi-phase voltage conversion device of the embodiment of FIG. 2A. The signals S1a, S1b, S2a, S2b in FIG. 2A may be generated according to the signal LG. The signal generating circuit 201 includes inverters DIV1, IV2, IV3, an AND gate AN1, and a NOR gate NOR1. The inverter DIV1 receives the signal LG. The inverter DIV1 provides a time delay, and is used to delay and invert the signal LG to generate the signal SS1. The AND gate AN1 receives the signals LG and SS1 and performs a logical AND operation on the signals LG and SS1 to generate the signal S1a. The NOR gate NOR1 receives the signals S1a and SS1 and performs a logical NOR operation on the signals S1a and SS1 to generate the signal S2a. The inverter IV2 is used to invert the signal S1a to generate the signal S1b, and the inverter IV3 is used to invert the signal S2a to generate the signal S2b.

Please refer to FIG. 2C, FIG. 2C shows a timing diagram of the multi-phase voltage conversion device of the embodiment of FIG. 2A. In the first time interval T1, the charging circuit 231 charges the capacitor C1 to pull up the voltage value of the current sensing signal VCS_D1. Then, in the second time interval T2, the discharging circuit 232 discharges the capacitor C1 to make the voltage value of the current sensing signal VCS_D1 drop linearly. The current sensing signal VCS_D1 may simulate the changing state of the sensed voltage VCS1, which may be considered as a copy signal of the sensed voltage VCS1.

In the embodiment of the present disclosure, the multi-phase voltage conversion device 200 may perform overcurrent detection through the current sensing signal VCS_D1 to start the overcurrent protection mechanism when necessary. Moreover, based on the current sensing of the current sensing signal VCS_D1, it may be possible to avoid current jitter caused by the switching operation of the transistor, thereby avoiding the false triggering of the overcurrent protection mechanism, and ensuring the normal operation of the multi-phase voltage conversion device.

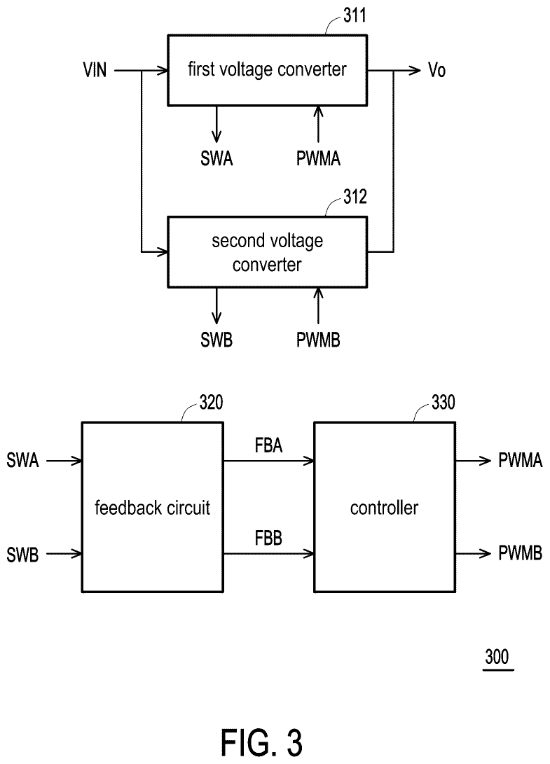

Please refer to FIG. 3, FIG. 3 shows a schematic view of a multi-phase voltage conversion device according to another embodiment of the present disclosure. The multi-phase voltage conversion device 300 includes a first voltage converter 311, a second voltage converter 312, a feedback circuit 320, and a controller 330. The first voltage converter 311 and the second voltage converter 312 are connected in parallel. The first voltage converter 311 and the second voltage converter 312 jointly receive an input voltage VIN, and perform voltage conversion operations according to control signals PWMA and PWMB respectively to jointly generate an output voltage Vo. The feedback circuit 320 is coupled to the switch end SWA of the first voltage converter 311 and the switch end SWB of the second voltage converter 312. The feedback circuit 320 generates multiple feedback signals FBA and FBB according to the switching voltages on the switch ends SWA and SWB, and the differential voltage between the output voltage Vo and a first reference voltage.

The controller 330 is coupled between the first voltage converter 311, the second voltage converter 312, and the feedback circuit 320. The controller 330 generates multiple sampling signals by sampling the control signals PWMA and PWMB, and adjusts the falling edge of one of the control signals PWMA and PWMB according to the multiple sampling signals and the feedback signals FBA and FBB, so that there is a time difference greater than a safety threshold between the falling edge of the control signal PWMA and the falling edge of the control signal PWMB.

By ensuring that the falling edges of control signals PWMA and PWMB have a sufficient time difference, the current sensing operation at switch ends SWA and SWB may have a sufficient sensing time, thereby reducing the possibility of sensing errors in the current sensing operation, and consequently decreasing the probability of the overcurrent protection mechanism being erroneously activated.

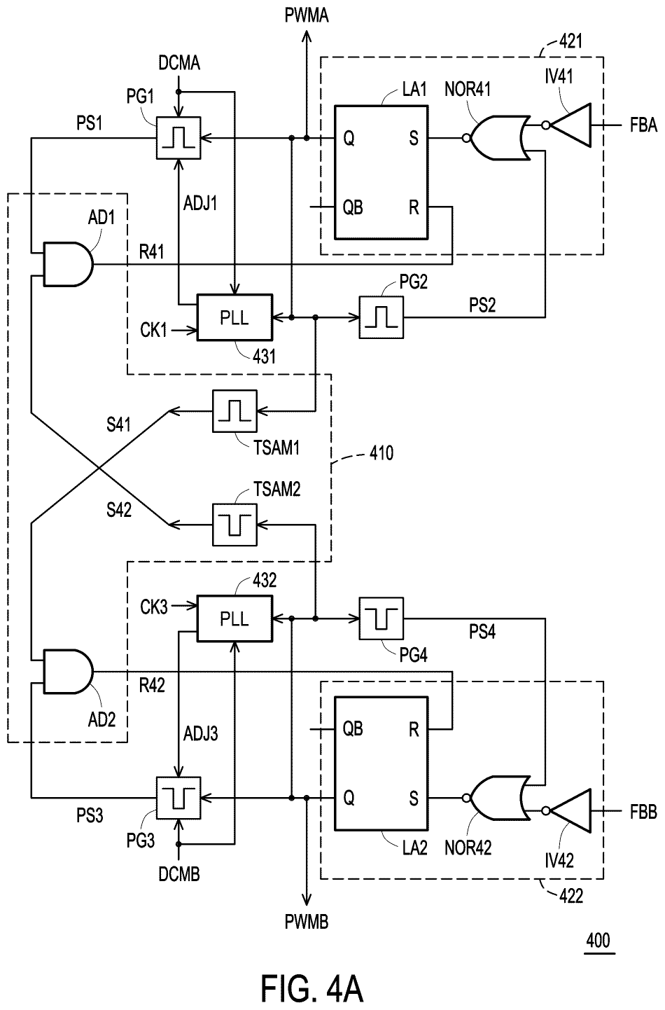

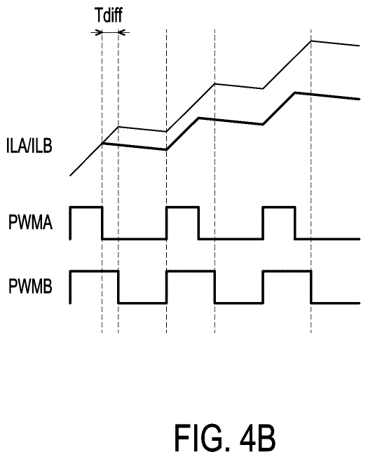

Please refer to FIG. 4A, FIG. 4A shows a schematic view of an implementation mode of a controller in a multi-phase voltage conversion device according to an embodiment of the present disclosure. The controller 400 includes an anti-transient interference circuit 410, logic circuits 421 and 422, phase-locked loops (PLL) 431 and 432, and pulse generators PG1 to PG4.

Logic circuits 421 and 422 respectively receive feedback signals FBA and FBB generated by the feedback circuit. The logic circuit 421 includes an inverter IV41, an NOR gate NOR41, and a latch LA1. The inverter IV41 receives a feedback signal FBA, the NOR gate NOR41 receives the output signal of the inverter IV41 and the pulse wave PS2 generated by the pulse generator PG2. The output end of the NOR gate NOR41 is coupled to the set end S of the latch LA1. In addition, the reset end R of the latch LA1 receives the reset signal R41. The output end Q of the latch LA1 generates a control signal PWMA, and outputs the control signal PWMA to the pulse generators PG1 and PG2, and the phase-locked loop 431.

The phase-locked loop 431 receives mode information DCMA, the control signal PWMA, and the clock signal CK1. The mode information DCMA is provided to control the activation or deactivation of the phase-locked loop 431. When the mode information DCMA indicates that the voltage conversion device is operating in discontinuous conduction mode (DCM), the phase-locked loop 431 may be turned off; conversely, when the mode information DCMA indicates that the voltage conversion device is operating in continuous conduction mode (CCM), the phase-locked loop 431 may be turned on. The phase-locked loop 431 outputs adjustment signal ADJ1 to the pulse generator PG1. The pulse generator PG1 may generate the pulse wave PS1 according to the mode information DCMA, the control signal PWMA, and the adjustment signal ADJ1, and the pulse generator PG2 may generate corresponding pulse wave PS2 according to the control signal PWMA.

The logic circuit 422 includes an inverter IV42, a NOR gate NOR42, and a latch LA2. The inverter IV42 receives the feedback signal FBB, the NOR gate NOR42 receives the output signal of the inverter IV42 and the pulse wave PS4 generated by the pulse generator PG4. The output end of the NOR gate NOR42 is coupled to the set end S of the latch LA2. In addition, the reset end R of the latch LA2 receives the reset signal R42. The output end Q of the latch LA2 generates the control signal PWMB, and outputs the control signal PWMB to the pulse generators PG3 and PG4, and the phase-locked loop 432. The phase-locked loop 432 receives the mode information DCMB, the control signal PWMB, and the clock signal CK3, and outputs the adjustment signal ADJ3 to the pulse generator PG3. The mode information DCMB is used to control the activation or deactivation of the phase-locked loop 432. The operation modes of the logic circuit 422, the phase-locked loop 432, the pulse generators PG3 and PG4 are similar to the operation modes of the aforementioned logic circuit 421, the phase-locked loop 431, the pulse generators PG1 and PG2, which will not be elaborated here. Through the phase-locked loops 431 and 432, in CCM mode, the control signal PWMA and the control signal PWMB generated by the latches LA1 and LA2 respectively may be interleaved with each other.

Incidentally, the latches LA1 and LA2 are both SR-type latches.

In addition, the anti-transient interference circuit 410 includes samplers TSAM1 and TSAM2 and logic gates AD1 and AD2. The sampler TSAM1 is provided to sample the control signal PWMA to generate a sampling signal S41. The sampler TSAM2 is provided to sample the control signal PWMB to generate a sampling signal S42. The logic gates AD1 and AD2 are both AND gates. The logic gate AD1 is provided to perform a logical AND operation on the sampling signal S42 and the pulse wave PS1 to generate a reset signal R41. The logic gate AD2 is provided to perform a logical AND operation on the sampling signal S41 and the pulse wave PS4 to generate a reset signal R42.

When the logic value of the control signal PWMA equals 0, the sampler TSAM1 generates a sampling signal S41 with a logic value of 0, and starts timing. When the time during which the logic value of the sampling signal S41 is 0 reaches a first preset time delay, the sampler TSAM1 changes the logic value of the sampling signal S41 to 1. The first preset time delay may be set by the designer according to the actual circuit requirements, without specific limitations, for example, the first preset time delay may be between tens to hundreds of nanoseconds, such as 100 nm. That is to say, the sampler TSAM1 may, upon detecting that the logic value of the control signal PWMA has changed to 0, provide a sampling signal S41 with a negative pulse wave of a specific width to the logic gate AD2. According to the negative pulse wave of the sampling signal S41, the logic gate AD2 may maintain the logic value of the reset signal R42 at 0 for a specific length of time, so that the reset operation of the latch LA2 may be delayed, and the width of the positive pulse wave of the control signal PWMB may be effectively expanded, thereby ensuring that the time difference between the falling edge of the control signal PWMB and the falling edge of the control signal PWMA is greater than the safety threshold.

Similar to the sampler TSAM1, when the logic value of the control signal PWMB equals 0, the sampler TSAM2 generates a sampling signal S42 with a logic value of 0, and starts timing. When the time during which the logic value of the sampling signal S42 is 0 reaches the second preset time delay, the sampler TSAM2 changes the logic value of the sampling signal S42 to 1. That is, the sampler TSAM2 may provide a sampling signal S42 with a negative pulse wave of a specific width to the logic gate AD1 when detecting that the logic value of the control signal PWMB has changed to 0. According to the negative pulse wave of the sampling signal S42, the logic gate AD1 may maintain the logic value of the reset signal R41 at 0 for a specific length of time, so that the reset operation of the latch LA1 may be delayed, and the width of the positive pulse wave of the control signal PWMA is effectively expanded, thereby ensuring that the time difference between the falling edge of the control signal PWMB and the falling edge of the control signal PWMA is greater than the safety threshold.

Please refer to FIG. 4B, FIG. 4B shows the timing diagram of the anti-transient interference circuit 410 of the embodiment of FIG. 4A of the present disclosure. By detecting the falling edge of the control signal PWMA to expand the width of the positive pulse wave of the control signal PWMB, it is possible to make the falling edges of the control signals PWMA and PWMB to have a time difference Tdiff. In this situation, the voltage switching operations caused by the falling edges of the control signals PWMA and PWMB will not affect the current sensing operations performed on the voltage converter. Therefore, the currents ILA and ILB sensed at the switch end of the voltage converter may avoid the jitter caused by switching interference, which helps reduce the possibility of the overcurrent protection mechanism being mistakenly activated.

An embodiment of the present disclosure provides a new current sensing solution, which generates mirror current through sensed current ICS1 of the mirror current sensor, and performs current sensing according to the current sensing signal VCS_D1 generated by the mirror current and the output voltage Vo. Since the current sensing signal VCS_D1 does not jitter due to interference generated by the switching operation of the transistor, current sensing performed through the current sensing signal VCS_D1 may make it possible to avoid current jitter caused by the switching operation of the transistor, thereby avoiding false triggering the overcurrent protection mechanism. In addition, the anti-transient interference circuit provided by the embodiment of the present disclosure controls the time difference between the falling edges of two control signals PWMA and PWMB corresponding to the voltage conversion operation, making the current sensing time long enough, which also helps to reduce the error of current sensing and mitigates the possibility of the overcurrent protection mechanism being mistakenly activated.

According to the above, in the multi-phase voltage conversion device of the present disclosure, by setting up a current sensing signal generator to copy the sensed voltage in the current sensor to generate a current sensing signal, it may be possible to overcome the interference caused by the switching operation of the voltage converter under steady-state conditions. Furthermore, in the multi-phase voltage conversion device of the present disclosure, by setting up a controller to make the falling edges of multiple control signals of the voltage converter have time differences greater than a safety threshold from each other, so that under transient response, the current sensing operations between multiple voltage converters will not interfere with each other. In this way, the current sensing operation of the multi-phase voltage conversion device of the present disclosure may be stably executed.

Finally, it should be noted that: the above embodiments are only used to explain the technical solution of the present disclosure, and not to limit it; although the present disclosure has been described in detail with reference to the foregoing embodiments, those skilled in the art should understand that they may still modify the technical solutions recorded in the foregoing embodiments, or make equivalent substitutions for some or all of the technical features; and these modifications or substitutions do not make the essence of the corresponding technical solutions deviate from the scope of the technical solutions of the embodiments of the present disclosure.

What is claimed is:

1. A multi-phase voltage conversion device, comprising:
a plurality of voltage converters, wherein the plurality of voltage converters are connected in parallel, and respectively generate an output voltage according to a plurality of control signals;
a plurality of current sensors, corresponding to the plurality of voltage converters one by one, where each of the current sensors is coupled to two ends of a switching switch of the corresponding voltage converter for sensing a sensed current on the switching switch; and
a plurality of current sensing signal generators, corresponding to the plurality of current sensors one by one, where each of the current sensing signal generators is coupled to the corresponding current sensor, generates a mirror current by mirroring the sensed current, and generates a current sensing signal according to the mirror current and the output voltage,
wherein the multi-phase voltage conversion device determines whether to activate an overcurrent protection mechanism according to the current sensing signal.

2. The multi-phase voltage conversion device according to claim 1, wherein the current sensing signal generator comprises:
a capacitor, wherein a first end of the capacitor is configured for generating the current sensing signal, a second end of the capacitor receives a reference voltage;
a charging circuit, coupled to the capacitor, for generating the mirror current by mirroring the sensed current, and charging the capacitor according to the mirror current in a first time interval to generate a charging voltage; and
a discharging circuit, coupled to the capacitor, for generating a discharge current according to the output voltage, and for discharging the capacitor in a second time interval according to the discharge current.

3. The multi-phase voltage conversion device according to claim 2, wherein the charging circuit comprises:
a current source, providing the mirror current through mirroring the sensed current;
a resistor, connected in series with the current source, and receiving the mirror current; and
a first switch, coupled between a coupling point between the current source and the resistor and the first end of the capacitor, and turned on in the first time interval and turned off in the second time interval.

4. The multi-phase voltage conversion device according to claim 3, wherein the discharging circuit comprises:
a current mirror, generating the discharge current according to the output voltage; and
a second switch, coupled between the current mirror and the first end of the capacitor, and turned off in the first time interval and turned on in the second time interval.

5. The multi-phase voltage conversion device according to claim 4, wherein the first switch and the second switch are transmission gates.

6. The multi-phase voltage conversion device according to claim 1, wherein the multi-phase voltage conversion device further comprises:
a feedback circuit, coupled to the plurality of voltage converters, configured to generate a plurality of feedback signals according to a switching voltage of the plurality of voltage converters and a differential voltage between the output voltage and a first reference voltage; and
a controller, coupled between the feedback circuit and the plurality of voltage converters, generating a plurality of sampling signals respectively through sampling the plurality of control signals, and adjusting a falling edge of one of the plurality of control signals according to the plurality of sampling signals and the plurality of feedback signals, so that a time difference between the falling edge of the plurality of control signals is greater than a safety threshold.

7. The multi-phase voltage conversion device according to claim 6, wherein the controller comprises:
a first phase-locked loop, receiving first mode information, a first control signal and a first clock signal, and outputting a first adjustment signal to a first pulse generator;
wherein the first pulse generator provides a first pulse wave according to the first mode information, the first control signal and the first adjustment signal;
a second pulse generator, providing a second pulse wave according to the first control signal;
a first logic circuit, configured to generate the first control signal according to a first feedback signal, a first reset signal, and the second pulse wave;
a second phase-locked loop, receiving second mode information, a second control signal and a second clock signal, and outputting a second adjustment signal to a third pulse generator;
wherein the third pulse generator provides a third pulse wave according to the second mode information, the second control signal and the second adjustment signal;
a fourth pulse generator, providing a fourth pulse wave according to the second control signal;
a second logic circuit, configured to generate the second control signal according to a second feedback signal, a second reset signal, and the fourth pulse wave; and
an anti-transient interference circuit, generating a first sampling signal and a second sampling signal respectively through sampling the first control signal and the second control signal, and making the second sampling signal and the first pulse wave to perform a logic operation to generate the first reset signal, and making the first sampling signal and the third pulse wave to performing a logic operation to generate the second reset signal.

8. The multi-phase voltage conversion device according to claim 7, wherein the anti-transient interference circuit comprises:
a first sampler, sampling the first control signal to generate the first sampling signal;
a second sampler, sampling the second control signal to generate the second sampling signal;
a first logic gate, for performing a logic operation on the second sampling signal and the first pulse wave to generate the first reset signal; and
a second logic gate, for performing a logic operation on the first sampling signal and the third pulse wave to generate the second reset signal.

9. The multi-phase voltage conversion device according to claim 8, wherein the first logic gate and the second logic gate are AND gates.

10. The multi-phase voltage conversion device according to claim 1, wherein the plurality of voltage converters comprises:
a first voltage converter, receiving an input voltage; and
a second voltage converter, wherein an output end of the second voltage converter is coupled to an output end of the first voltage converter, the second voltage converter receives the input voltage,
wherein the first voltage converter and the second voltage converter respectively convert the input voltage according to a first control signal and a second control signal to jointly generate the output voltage.
